(19) United States
(12) Patent Application Publication
(10) Pub. No.: US 2007/0055768 A1
(43) Pub. Date: Mar. 8, 2007

(54) Method and system for monitoring a server

(75) Inventor: James O'Toole, Somerville, MA (US)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/209,431

(22) Filed: Aug. 23, 2005

(51) Int. Cl. G06F 15/173

(52) U.S. Cl. 709/224

(57) ABSTRACT

A method, system, apparatus and machine-readable medium for monitoring a server in a network is provided. Based on a predefined condition, at least one reference value of the server is updated, the reference value being determined from a reference Uniform Resource Locator (URL). Subsequently, a test URL of the server is used to determine a test value of the server. The state of the server is determined, based on a comparison between the test value and the reference value.

### BACKGROUND OF THE INVENTION

1. Field of Invention

Embodiments of the present invention relate in general to the field of computer networks. More specifically, the embodiments of this invention relate to methods and systems for monitoring the availability of servers in computer networks.

2. Description of the Background Art

The known computer networks comprise a plurality of servers, which contain a variety of resources. A client requiring a resource connects to a server, including the resource using a front end, which may be a web browser. This enables effective real-time communication between the server and the client in a typical server-client model.

In such a server-client model, a server may malfunction and may be unable to serve a client, and continue to do so indefinitely. Therefore, the availability of servers in a computer network is monitored, in order to send an alert if the server has become unavailable.

The current state of the art offers various systems and methods as a solution to this problem. One of them is scripted health check, which performs a single-step probe to determine the condition of a server in a network. Another one is a hypertext transfer protocol-get (HTTP-get) method, which conducts a two-step probe. The first step of the HTTP-get is an initialization step. This includes the calculation of a reference hash value, using the Uniform Resource Locator (URL) of the server and storing the reference hash value in a load-balancing switch for future reference. After a fixed interval, a monitoring step is performed, wherein the hash value of the server is compared with the previously stored reference hash value. The server is declared to be functioning, if the hash value is the same as the reference hash value. However, if the hash value is different from the reference hash value, the server is declared to be malfunctioning.

If the server is malfunctioning, the HTTP-get method may store a false reference hash value at the initialization step. As a result, at the monitoring step, a comparison is made with the false reference hash value and the condition of the server is wrongly determined. This affects the functioning of the network, because no corrective measures are taken if it is declared that a malfunctioning server is functioning.

### BRIEF DESCRIPTION OF THE DRAWINGS

FIG. 1 illustrates an exemplary environment of a network, in which various embodiments of the invention can be implemented.

FIG. 2 is a flowchart illustrating a method for updating a reference value, in accordance with an embodiment of the invention.

FIG. 3 is a flowchart illustrating a method for monitoring the state of a target server in a network, in accordance with an embodiment of the invention.

FIG. 4 illustrates the elements of a system, in accordance with an embodiment of the invention.

FIG. 5 is a block diagram of the elements of a reference value-updating unit, in accordance with an embodiment of the invention.

FIG. 6 is a block diagram of the elements of a test value calculator, in accordance with an embodiment of the invention.

### DETAILED DESCRIPTION OF EMBODIMENTS OF THE INVENTION

Embodiments of the invention provide a method, system, apparatus and machine-readable medium for monitoring a server in a network. The server may be a web server or an application server. In accordance with various embodiments of the invention, the method, system, apparatus and machine-readable medium are implemented to update at least one reference value for monitoring a target server in a network. The method includes determining whether a reference value is to be updated, based on a predefined condition. If the reference value is to be updated, a Hyper Text Transfer Protocol-get (HTTP-get) operation is performed on a reference Uniform Resource Locator (URL). The reference URL is provided by the target server or a reference server in the network. Hashing is a mathematical function, to calculate a numerical value from a URL. The numerical value calculated is unique for each URL. Hashing the result of the HTTP-get operation updates the reference value. According to various embodiments of the invention, the method, system, apparatus and machine-readable medium enable comparison between a test URL and a reference URL. This is achieved by a comparison between a test value, corresponding to the test URL, and the reference value corresponding to the reference URL.

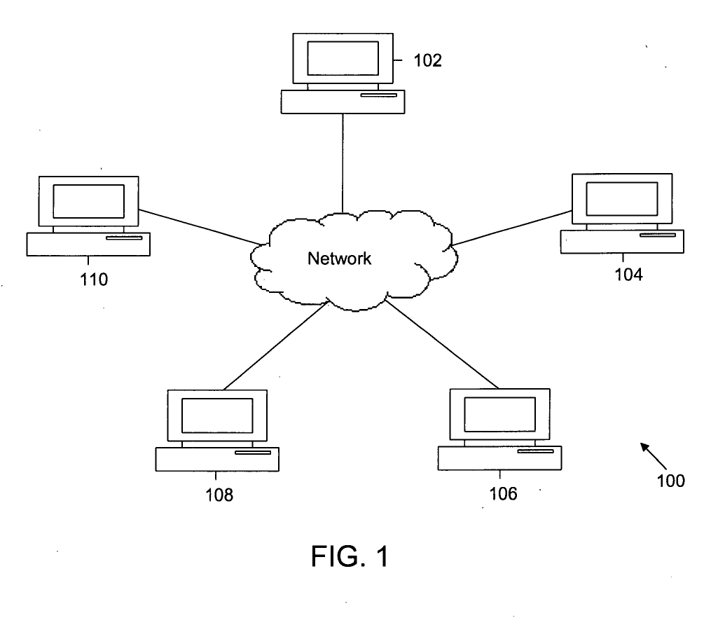

FIG. 1 illustrates an exemplary environment of a network 100, in which various embodiments of the invention can be implemented. Network 100 may be a local area network (LAN), a wide area network (WAN), or an Internet-enabled network. Network 100 includes a plurality of data-processing units, for example, data-processing units 102, 104, 106, 108, and 110. One or more data-processing units of network 100 may be servers.

Data-processing unit 108 is hereinafter referred to as target server 108, which may be prone to errors and may therefore malfunction. Hence, the state of target server 108 is monitored, so that corrective action can be taken if target server 108 malfunctions.

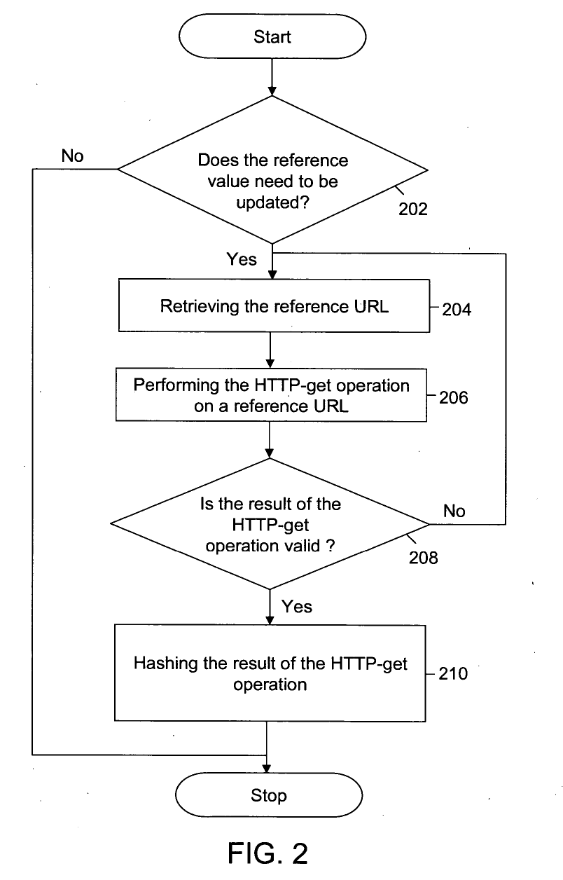

FIG. 2 is a flowchart illustrating a method for updating a reference value for monitoring target server 108 in network 100, in accordance with an embodiment of the invention. The reference value is used as a reference to determine whether target server 108 is in a functioning state, a malfunctioning state, or an ambiguous state. At step 202, it is determined whether the reference value is to be updated, based on a predefined condition. The predefined condition includes verifying if any content changes have occurred in network 100. In an embodiment of the invention, a content change may be changing a URL of a server in network 100. In another embodiment of the invention, the content change may be a change in the number of servers in network 100.

If the predefined condition is true, it is determined that at least one reference value is to be updated. If the reference value is to be updated, then, after a fixed interval, the reference URL of target server 108 is retrieved from a configurator at step 204. An exemplary fixed interval may be defined by the system administrator. In an embodiment of the invention, the configurator may be a part of a load-balancing switch. Data processing unit 106 is hereinafter referred to as load-balancing switch 106, which has been described in subsequent figures. The configurator is an application that enables users to add data-processing units, or modify or delete existing ones. The configurator provides descriptor information, URL, the data-processing unit name, and IP address information for the data-processing units in network 100.

In an embodiment of the invention, the reference URL may be retrieved from a reference server. Data-processing unit 110 is hereinafter referred as reference server 110. The state of reference server 110 may be functioning or malfunctioning, and is fixed at the beginning. Reference server 110 is used primarily as a reference to a plurality of target servers, all of which may be tested and monitored in the same way as target server 108. Reference server 110 comprises dedicated hardware, which permits limited communication between reference server 110 and network 100. Limited communication includes receiving a notification, if there are content changes in target server 108 in network 100. Further, reference server 110 includes a server state-monitoring software, which is designed to force reference server 110 to fail-stop, in the event reference server 110 is unable to provide a valid reference URL. This ensures that reference server 110 does not provide an invalid reference URL, and a valid reference URL is retrieved consistently.

At step 206, a Hyper Text Transfer Protocol-get (HTTP-get) operation is performed on the reference URL, to obtain a result. In an embodiment of the invention, the reference URL may be directing to target 108. In another embodiment of the invention, the reference URL may be directing to reference server 110. At step 208, the validity of the result of the HTTP-get operation is determined on the basis of a predetermined condition. The predetermined condition is false if the headers are invalid, the length of the URL is invalid, the connectivity is improper, the Transfer Control Protocol (TCP) has been reset, or an HTTP error code has been returned. If the predetermined condition is false, then after a predetermined time interval, the reference URL is again retrieved at step 204. According to an embodiment of the invention, the predetermined time interval may be a configurable parameter ranging from 1 second to at least 100,000 seconds. Subsequently, the HTTP-get operation is again performed on the reference URL at step 206. Thereafter, the predetermined condition is again checked at step 208. In this manner, the reference URL is periodically retrieved until a valid reference URL is received. However, if the predetermined condition is true, the result of the HTTP-get operation is hashed and a unique numerical value of the reference URL is provided. This numerical value is the updated reference value. For example, a value generated by hashing may be ‘3f80f-1b6-3e1cb03b’, and after application of md5 hashing algorithm, the result may be ‘2c4ffdf59938e8d13dc0e0f3e33a0f05’. According to an embodiment of the invention, a comparison of the first N characters of the reference results and the test results may be done using a hash function such as md5 or, a computationally cheaper hash function. The reference value is stored in a load-balancing switch 106, which makes a request for the test URL at user-specified intervals, and compares the test URL with the reference URL. This is achieved by the comparison between the test value corresponding to the test URL, and the reference value corresponding to the reference URL. Based on this comparison, the load-balancing switch determines the state of target server 108. Further, the load balancing switch stores statistics of the number of servers that are malfunctioning, and the current and cumulative downtime of each server in network 100. According to the various embodiments of the invention, the information configured for monitoring target server 108 may be applicable for a ‘group’ of target servers. Each group of target servers is then tested and monitored individually.

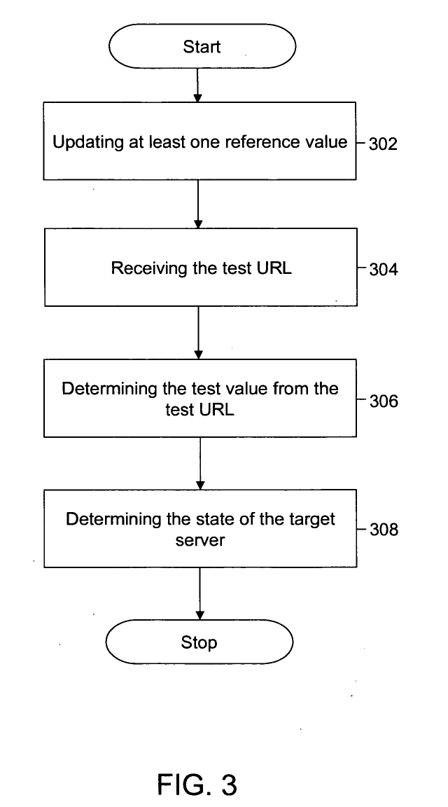

FIG. 3 is a flowchart illustrating a method for monitoring target server 108 in network 100, in accordance with various embodiments of the invention. At step 302, at least one reference value is updated, which has been explained in conjunction with FIG. 2. At step 304, the configurator provides the load balancing switch with the test URL of target server 108, as a parameter for monitoring the state of target server 108, which has been described in conjunction with FIG. 2. The HTTP-get operation is performed on the test URL. Hashing the result of this HTTP-get operation provides the test value. The test value is thus determined from the test URL at step 306. Thereafter, the comparison is performed between the test value and the reference value, which indirectly serves as the comparison between the test URL and the reference URL. Based on this comparison, the state of target server 108 is determined at step 308.

According to various embodiments of the invention, it is determined that target server 108 is in the functioning, if the test value is equal to a reference good value. The reference good value is retrieved from target server 108 or reference server 110. The reference good value indicates that one of target server 108 or reference server 110 is in the functioning state.

According to various other embodiments, target server 108 is determined to be in the malfunctioning state, if the test value is not equal to the reference good value.

In another embodiment of the invention, target server 108 is determined to be in the malfunctioning state, if the test value is equal to a reference bad value. The reference bad value is retrieved from reference server 110 and indicates that reference server 110 is in the malfunctioning state.

In various embodiments of the invention, if target server 108 is identified in a malfunctioning state, then target server 108 is removed from active service.

In another embodiment of the invention, if the test value is neither equal to the reference good value nor equal to the reference bad value, then target server 108 is in the ambiguous state.

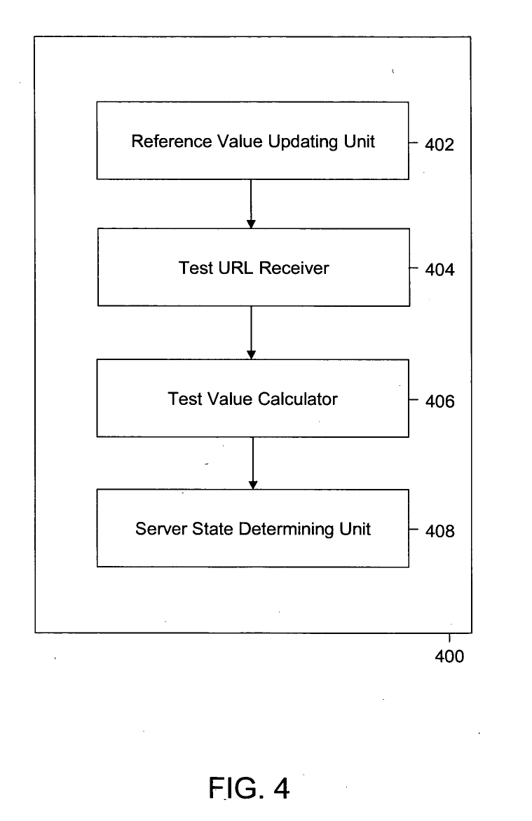

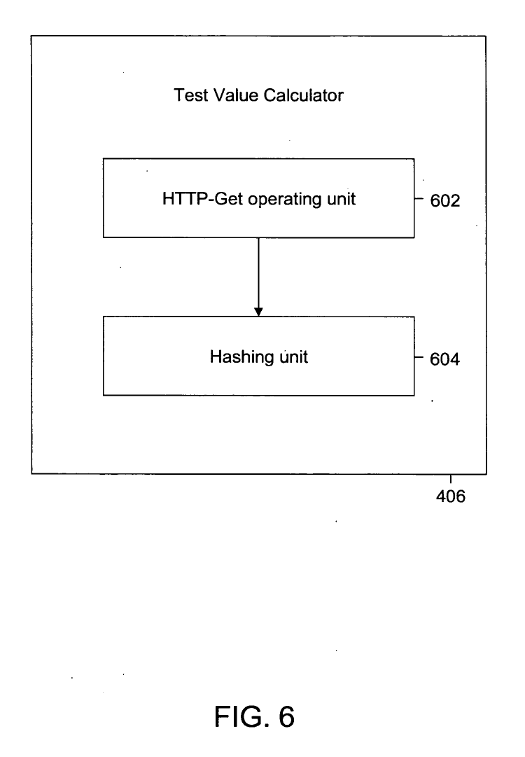

FIG. 4 illustrates the elements of a system 400, in accordance with an embodiment of the invention. System 400 may be load-balancing switch 106. System 400 includes a reference value-updating unit 402, a test URL receiver 404, a test value calculator 406, and a server state-determining unit 408. In various embodiments of the invention, each of the system elements of system 400 is implemented in the form of software, hardware, firmware, or a combination thereof. If the predefined condition, described in conjunction with FIG. 2, is true, then at least one reference value is updated by reference value-updating unit 402. The configurator provides test URL receiver 404 with the test URL of target server 108. Test value calculator 406 calculates the test value from the test URL, which is explained later in conjunction with FIG. 6. Server state-determining unit 408 determines the state of target server 108, based on the comparison between the test value and the reference value. This indirectly serves as the comparison between the test URL and the reference URL, as has been described in conjunction with FIG. 3.

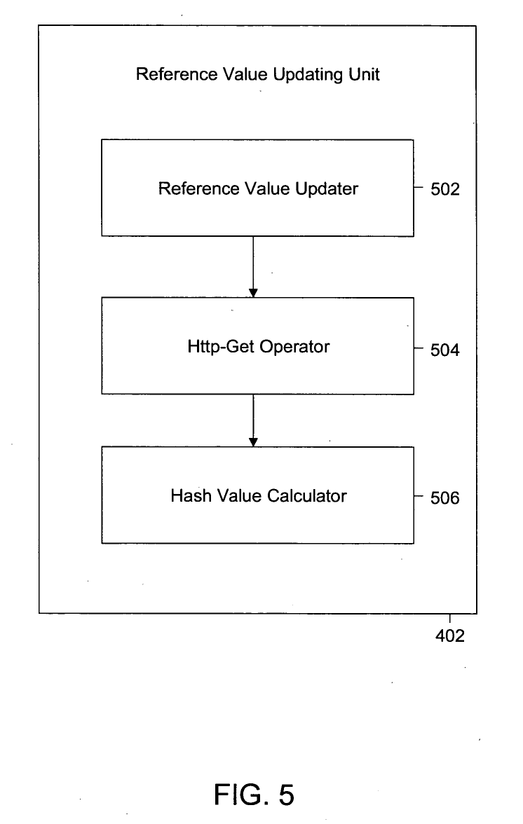

FIG. 5 is a block diagram of the elements of reference value-updating unit 402, in accordance with an embodiment of the invention. Reference value-updating unit 402 includes a reference value updater 502, an HTTP-get operator 504, and a hash value calculator 506. Reference value updater 502 determines whether the reference value is to be updated, based on the predefined condition, which has been explained in conjunction with FIG. 2. HTTP-get operator 504 performs the HTTP-get operation on the reference URL, upon receiving a response from reference value updater 502. Thereafter, hash value calculator 506 hashes the result from HTTP-get operator 504, thereby updating the reference value. This reference value is used as a reference for determining the state of target server 108. The various embodiments of the state of target server 108 have been explained in conjunction with FIG. 3.

FIG. 6 is a block diagram of the elements of test value calculator 406, in accordance with an embodiment of the invention. Test value calculator 406 includes an HTTP-get operation unit 602, and a hashing unit 604. HTTP-get operation unit 602 performs the HTTP-get operation on the test URL. Hashing unit 604 hashes the result of the HTTP-get operation, which determines the test value. This test value is compared with the reference value to determine the state of target server 108. The various embodiments of the state of target server 108 have been described in conjunction with FIG. 3.

Embodiments of the present invention have the advantage that target server 108 in network 100 can be reliably monitored. Further, the embodiments of the invention provide a method, system, apparatus and machine-readable medium to identify and remove target server 108 in the malfunctioning state from active service. Furthermore, the various embodiments of the invention can identify and ignore the static content of target server 108 in the malfunctioning state. This ensures that the retrieved reference value is correct. Additionally, the use of reference server 110 removes a boot or power-failure-reset reliability problem, which develops due to race conditions. Race conditions develop when target server 108 and the corresponding load balancing switch initialize concurrently. Further, the embodiments of the invention operate at a low cost and a high frequency of monitoring target server 108.

Although the invention has been discussed with respect to specific embodiments thereof, these embodiments are merely illustrative, and not restrictive, of the invention. For example, a ‘method for updating at least one reference value for monitoring a target server in a network’ can include any type of analysis, manual or automatic, to anticipate the needs of monitoring a server system.

Although specific protocols have been used to describe embodiments, other embodiments can use other transmission protocols or standards. Use of the terms ‘peer’, ‘client’, and ‘server’ can include any type of device, operation, or other process. The present invention can operate between any two processes or entities including users, devices, functional systems, or combinations of hardware and software. Peer-to-peer networks and any other networks or systems where the roles of client and server are switched, change dynamically, or are not even present, are within the scope of the invention.

Any suitable programming language can be used to implement the routines of the present invention including C, C++, Java, assembly language, etc. Different programming techniques such as procedural or object oriented can be employed. The routines can execute on a single processing device or multiple processors. Although the steps, operations, or computations may be presented in a specific order, this order may be changed in different embodiments. In some embodiments, multiple steps shown sequentially in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Also in the description herein for embodiments of the present invention, a portion of the disclosure recited in the specification contains material, which is subject to copyright protection. Computer program source code, object code, instructions, text or other functional information that is executable by a machine may be included in an appendix, tables, figures or in other forms. The copyright owner has no objection to the facsimile reproduction of the specification as filed in the Patent and Trademark Office. Otherwise all copyright rights are reserved.

A ‘computer’ for purposes of embodiments of the present invention may include any processor-containing device, such as a mainframe computer, personal computer, laptop, notebook, microcomputer, server, personal data manager or ‘PIM’ (also referred to as a personal information manager), smart cellular or other phone, so-called smart card, set-top box, or any of the like. A ‘computer program’ may include any suitable locally or remotely executable program or sequence of coded instructions, which are to be inserted into a computer, well known to those skilled in the art. Stated more specifically, a computer program includes an organized list of instructions that, when executed, causes the computer to behave in a predetermined manner. A computer program contains a list of ingredients (called variables) and a list of directions (called statements) that tell the computer what to do with the variables. The variables may represent numeric data, text, audio or graphical images. If a computer is employed for presenting media via a suitable directly or indirectly coupled input/output (I/O) device, the computer would have suitable instructions for allowing a user to input or output (e.g., present) program code and/or data information respectively in accordance with the embodiments of the present invention.

A ‘computer readable medium’ for purposes of embodiments of the present invention may be any medium that can contain, store, communicate, propagate, or transport the computer program for use by or in connection with the instruction execution system apparatus, system or device. The computer readable medium can be, by way of example only but not by limitation, an electronic, magnetic, optical, electromagnetic, infrared, or semiconductor system, apparatus, system, device, propagation medium, or computer memory.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general-purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for updating at least one reference value for monitoring a target server in a network, the method comprising:
determining whether the reference value is to be updated based on a predefined condition;
performing a Hyper Text Transfer Protocol-get (HTTP-get) operation on a reference Uniform Resource Locator (URL), in response to determining that the reference value is to be updated, the reference URL being one of the URL of the target server and the URL of a reference server in the network; and
hashing the result of the HTTP-get operation.

2. The method according to claim 1, wherein the predefined condition comprises content changes in the network.

3. The method according to claim 1, wherein the reference value indicates that one of the target server and the reference server is in a functioning state.

4. The method according to claim 1, wherein the reference value indicates that the reference server is in a malfunctioning state.

5. The method according to claim 1, wherein the method further comprises determining whether the result of the HTTP-get operation is valid based on a predetermined condition.

6. The method according to claim 5, wherein the predetermined condition comprises at least one of the headers being valid, length of URL being valid, connectivity being proper, Transfer Control Protocol (TCP) not being reset, and no HTTP error code being returned.

7. A method for monitoring a target server in a network, wherein the method comprises:
updating at least one reference value;
receiving a test Uniform Resource Locator (URL) of the target server;
determining a test value, the test value being determined from the test URL; and
determining the state of the target server, based on a comparison between the test value and the reference value.

8. The method according to claim 7, wherein updating at least one reference value comprises:
determining whether the reference value is to be updated based on a predefined condition;
performing a Hyper Text Transfer Protocol-get (HTTP-get) operation on a reference Uniform Resource Locator (URL), in response to determining that the reference value is to be updated, the reference URL being one of the URL of the target server and the URL of a reference server in the network; and
hashing the result of the HTTP-get operation performed on the reference URL.

9. The method according to claim 8, wherein the predefined condition comprises content changes in the network.

10. The method according to claim 8, wherein determining the test value comprises:
performing a Hyper Text Transfer Protocol-get (HTTP-get) operation on the test URL; and
hashing the result of the HTTP-get operation performed on the test URL.

11. The method according to claim 8, wherein the reference value indicates that one of the target server and the reference server is in a functioning state.

12. The method according to claim 8, wherein the reference value indicates that the reference server is in a malfunctioning state.

13. The method according to claim 7, wherein the target serverbeing in a functioning state, if the test value is equal to a reference good value, wherein the reference good value indicates that one of the target server and the reference server is in a functioning state.

14. The method according to claim 7, wherein the target server being in a malfunctioning state, if the test value is not equal to a reference good value, wherein the reference good value indicates that one of the target server and the reference server is in a functioning state.

15. The method according to claim 7, wherein the target server being in a malfunctioning state, if the test value is equal to a reference bad value, wherein the reference bad value indicates that the reference server is in a malfunctioning state.

16. The method according to claim 7, wherein the target server is in an ambiguous state, if the test value is neither equal to a reference good value, nor equal to a reference bad value, the reference good value being a reference value which indicates that one of the target server and the reference server is in a functioning state, and the reference bad value being another reference value which indicates that the reference server is in a malfunctioning state.

17. A system for updating at least one reference value for monitoring a target server in a network, the system comprising:
means for determining whether the reference value is to be updated based on a predefined condition;
means for performing a Hyper Text Transfer Protocol-get (HTTP-get) operation on a reference Uniform Resource Locator (URL), in response to determining that the reference value is to be updated, the reference URL being one of the URL of the target server and the URL of a reference server in the network; and
means for hashing the result of the HTTP-get operation.

18. A system for monitoring a target server in a network, wherein the system comprises:
a reference value updating unit for updating at least one reference value;
a test URL receiver for receiving a test Uniform Resource Locator (URL) of the target server;
a test value calculator for determining a test value, the test value being determined from the test URL; and
a server state determining unit for determining the state of the target server, based on a comparison between the test value and the reference value.

19. The system according to claim 18, wherein the reference value updating unit comprises:
a reference value updater for determining whether the reference value is to be updated based on a predefined condition;
a Hyper Text Transfer Protocol-get (HTTP-get) operator for performing an HTTP-get operation on a reference URL upon receiving a response from the reference value updater, the reference URL being one of the URL of the target server and the URL of a reference server in the network; and
a hash value calculator for hashing the result of the HTTP-get operation.

20. The system according to claim 18, wherein the test value calculator comprises:
a Hyper Text Transfer Protocol-get (HTTP-get) operating unit for performing an HTTP-get operation on a test URL; and
a hashing unit for hashing the result of the HTTP-get operation.

21. The system according to claim 18, wherein the target server being in a functioning state, if the test value is equal to a reference good value, wherein the reference good value indicates that one of the target server and the reference server is in a functioning state.

22. The system according to claim 18, wherein the target server being in a malfunctioning state, if the test value is not equal to a reference good value, wherein the reference good value indicates that one of the target server and the reference server is in a functioning state.

23. The system according to claim 18, wherein the target server being in a malfunctioning state, if the test value is equal to a reference bad value, wherein the reference bad value indicates that the reference server is in a malfunctioning state.

24. The system according to claim 18, wherein the target server is in an ambiguous state, if the test value is neither equal to a reference good value, nor equal to a reference bad value, the reference good value being a reference value which indicates that one of the target server and the reference server is in a functioning state, and the reference bad value being another reference value which indicates that the reference server is in a malfunctioning state.

25. A machine-readable medium including instructions for monitoring a target server in a network, executable by the processor comprising:
one or more instructions for updating at least one reference value;
one or more instructions for receiving a test Uniform Resource Locator (URL) of the target server;
one or more instructions for determining a test value, the test value being determined from the test URL; and
one or more instructions for determining the state of the target server, based on a comparison between the test value and the reference value.

26. An apparatus for monitoring a target server in a network, the apparatus comprising
a processing system including a processor coupled to a display and user input device; and
a machine-readable medium including instructions executable by the processor comprising:
one or more instructions for updating at least one reference value;
one or more instructions for receiving a test Uniform Resource Locator (URL) of the target server;
one or more instructions for determining a test value, the test value being determined from the test URL; and
one or more instructions for determining the state of the target server, based on a comparison between the test value and the reference value.
